(19) United States
(12) Patent Application Publication
(10) Pub. No.: US 2012/0003425 A1
(43) Pub. Date: Jan. 5, 2012

(54) TiAIN COATINGS FOR GLASS MOLDING DIES AND TOOLING

(75) Inventors: Sudhir Brahmandam, Irwin, PA (US); Irene Spitsberg, Export, PA (US); Michael James Verti, Murrysville, PA (US)

(73) Assignee: Kennametal Inc., Latrobe, PA (US)

(21) Appl. No.: 12/827,294

(22) Filed: Jun. 30, 2010

(51) Int. Cl. C09D 1/00; B32B 9/00; B32B 15/04; B28B 7/38; B32B 3/00

(52) U.S. Cl. 428/141; 106/286.2; 427/133; 428/336; 428/457; 428/698

(57) ABSTRACT

A system for precision glass molding comprising a substrate and a coating. The substrate has less than 1.2 wt. % minor constituents. The coating comprises TiAlₓN_{y}, wherein x is about 0.7-1.5 and y is about 2.0-3.0. The coating is applied on at least a portion of the substrate.

### FIELD OF THE INVENTION

The invention is directed to a system for use in glass molding processes, and more particularly, to a system comprising titanium aluminum nitride (TiAlN) coatings for use in glass molding processes.

### BACKGROUND INFORMATION

Precision glass molding is extensively used for making optical lenses out of glass for a variety of applications including, for example, cameras, microscopes and collimators. Two methods are commonly used for producing lenses in glass-making processes. One method includes precision grinding a lens from glass performs while the other method includes preparing a high precision mold for molding glass lenses. Due to the associated time and cost savings, the second method is widely used for high volume lenses. In this method, the typical mold material used is WC—Co for low reactivity glass as well as low molding temperatures (i.e., less than 600° C.). In some instances, the mold material may or may not include a coating such as a diamond like carbon (DLC) coating. However, lens producers are moving towards glass compositions that contain reactive elements, such as fluorine, potassium, sodium, aluminum, phosphorous, germanium and thus require processing at higher molding temperatures. In doing so, they have found that the current WC—Co mold materials and/or coatings thereon do not perform satisfactorily under the higher temperature conditions due to the mold material and/or coating being unstable at higher temperatures and/or due to the mold material and/or coating reacting with the glass.

Typically, silicate and non-silicate glasses have been used due to their wide range of optical properties which in turn helps to create lenses for a large variety of applications. However, some of these glasses have higher softening temperatures and/or exhibit greater reactivity. Therefore, while the current precision glass molding approach of using WC—Co based molds and/or coatings may be successful for molding at lower softening temperature and/or with less reactive glasses, these materials still fail at temperatures above 600° C. and with more reactive glasses.

Additionally, a variety of coatings have been considered, such as TiN, Ti—B—C—N, Ni—Al—N, Mo-M (where M is Re, Hf, Tc or Os) and Pt—Ir. However, testing of some of these coatings have revealed that they cannot handle reactive glasses at temperatures above 600° C. Moreover, the Pt or precious group metal based coatings are prohibitively expensive.

In addition to the coating exhibiting an inertness to the reactive glass, it is also important that the coating does not change the profile accuracy of the mold by more than a critical amount while also retaining a requisite surface finish. The profile accuracy refers to the deviation of the formed mold at any point on the mold from the formula determined geometric surface. Typically, the allowed profile accuracy deviation is less than 0.5 μm. Additionally, the surface finish of a coated mold is typically less than 5 nm. If either the profile accuracy or surface finish deviates from the acceptable ranges, the optical performance of the lens may be compromised.

One manner by which to achieve the desired profile accuracy and surface finish is to limit the coating to a certain thickness and use, for example, a thin coating. However, a problem with thin coatings, especially at higher temperatures is significant diffusion of the binder and other species in the substrate through the coating. These diffusing species in turn react with glass and lead to failure of the mold. Alternatively, a thicker coating may be deposited on the substrate to avoid such problems. However, thicker coatings often require post coating operations, for example, polishing in order to achieve the required profile and/or surface finish. Such post coating operations, however, add additional costs to the mold as well as increase the production time of the molds.

Accordingly, there is a need for a cost effective material system for precision glass molding operations which is chemically inert at high molding temperatures.

### SUMMARY OF THE INVENTION

A coating composition comprising TiAlₓN_{y}, where x is about 0.7-1.5, such as 0.8-1.2, and y is about 2.0-3.0, such as 2.2-3.0, and such as 2.2-2.7. In embodiments, a substrate is coated with a composition of TiAlₓN_{y}, where x is about 0.7-1.5, such as 0.8-1.2, and y is about 2.0-3.0, such as 2.2-3.0, and such as 2.2-2.7. The substrate may have a coating thickness of less than about 1.0 μm.

Other embodiments are directed to a system for precision glass molding. The system includes a substrate and a coating on at least a portion thereon. The coating comprises TiAlₓN_{y}, where x is about 0.7-1.5, such as 0.8-1.2 and y is about 2.0-3.0, such as 2.2-2.7. The substrate may include less than 1.2% minor constituents of the total weight of the substrate. The minor constituents may include at least one of for example, cobalt, chromium or nickel. The substrate may include monotungsten carbide having less than 1.2 wt. % minor constituents. The coating thickness may be less than about 1.0 μm, such as about 0.5 μm. The surface roughness (RMS) of the coated substrate may be about less than about 5 nm. The coated substrate may have a profile accuracy of less than about 0.5 μm. The system may also include an intermediate layer between the substrate and the coating. The intermediate layer may include tungsten carbide, tungsten or a combination thereof having less than about 1.2 wt. % minor constituents.

Other embodiments are directed to a method of coating a substrate. The substrate may include less than 1.2 wt. % minor constituents and the coating may include TiAlₓN_{y}, where x is about 0.7-1.5, such as 0.8-1.2 and y is about 2.0-3.0, such as 2.2-2.7. The coating thickness may be less than about 1.0 μm, such as about 0.5 μm. The method may further include surface treating the coated substrate. The method may further include applying an intermediate layer prior to coating the substrate. The intermediate layer may include tungsten carbide, tungsten or a combination thereof.

These and other aspects of the present invention will be more apparent from the following description.

### BRIEF DESCRIPTION OF THE DRAWINGS

FIGS. 1A and 1B are a photomicrograph of a substrate with a DLC coating prior to heat treatment and after heat treatment, respectively.

FIGS. 2A and 2B are a photomicrograph of a substrate with a TiN coating prior to heat treatment and after heat treatment, respectively.

FIGS. 3A and 3B are a photomicrograph of a substrate with a TiAlN coating in accordance with the present invention prior to heat treatment and after heat treatment, respectively.

FIG. 4 is a photomicrograph of a substrate coated with a coating in accordance with the present invention in contact with Glass Composition A.

FIG. 5 is a photomicrograph of a substrate coated with a coating in accordance with the present invention in contact with Glass Composition B.

FIGS. 6A and 6B are a photomicrograph of a substrate coated with Ti₁₆Al₂₇N₅₇ in contact with Glass Composition B glass prior to exposure and after exposure to high temperature, respectively.

FIGS. 7A and 7B are a photomicrograph of a substrate coated with DLC in contact with Glass Composition B glass prior to exposure and after exposure to high temperature, respectively.

FIGS. 8A and 8B are a photomicrograph of a substrate coated with TiN in contact with Glass Composition B glass prior to exposure and after exposure to high temperature, respectively.

### DETAILED DESCRIPTION

Before the present materials, methods and systems are described, it is to be understood that this disclosure is not limited to the particular methodologies and materials described, as these may vary. It is also to be understood that the terminology used in the description is for the purpose of describing the particular versions or embodiments only, and is not intended to limit the scope. For example, as used herein and in the appended claims, the singular forms “a”, “an”, and “the” include plural references unless the context clearly dictates otherwise. For example, while reference is made herein to “a” mold, “a” coating, “a” glass, and the like, one or more of these or any other components can be used. In addition, the word “comprising” as used herein is intended to mean “including but not limited to”. Unless defined otherwise, all technical and scientific terms used herein have the same meanings as commonly understood by one of ordinary skill in the art.

The invention is generally directed to a chemically inert material system for use in precision glass molding processes. The system includes a substrate and a coating. In embodiments, the system may include an intermediate layer between the substrate and the coating.

The substrate may be any mold, blank, semi-finished or finished article. In embodiments, the substrate is a mold or die. Suitable substrates of the system include high purity materials. In embodiments, the high purity substrate material has less than about 1.2 wt. % minor constituents of the total weight of the substrate, such as less than about 1.0 wt. % minor constituents. Minor constituents may include, for example, nickel, vanadium, chromium, titanium, cobalt and the like, as well as impurities, such as iron, calcium, potassium and the like.

Suitable materials for the substrate may include tungsten carbide, tungsten and the like. For example, the substrate may be a tungsten carbide material having no more than about 1.2 wt. % minor constituents. In other embodiments, a tungsten carbide substrate may have less than about 0.45 wt. % cobalt, such as less than about 0.4 wt. % cobalt. Yet, in other embodiments, a tungsten carbide substrate may have less than about 1.0 wt. % of chromium, such as less than about 0.95 wt. % chromium.

In embodiments, the substrate may be a tungsten carbide substrate having carbon at or near stoichiometry, a low binder content, a low impurity content and a uniform and nonminal grain size of less than about 0.5 microns. In an embodiment, the substrate is a tungsten carbide material having about 6.06-6.13 wt. % carbon, about 0.20-0.55 wt. % grain growth inhibitor, less than about 0.25 wt. % binder, less than about 0.6 wt. % impurities, and balance being tungsten. The tungsten carbide substrate may have a nominal grain size of less than about 0.5 microns, such as about 0.25 to 0.4 microns. The binder content may be from about 0.1 to 0.15 wt. % cobalt. The carbon content may be from about 6.09 to 6.10 wt. %. The tungsten carbide substrate may consist essentially of monotungsten carbide. The grain growth inhibitor may be vanadium carbide, chromium carbide, niobium carbide, or a combination thereof. The tungsten carbide substrate may have a density of at least 98% of theoretical density and a void volume of less than 2%. Suitable high purity tungsten carbide materials include those described in U.S. patent application Ser. No. 12/615,885, filed Nov. 10, 2009 entitled “Inert High Hardness Material for Tool Lens Production in Imaging Applications”, paragraphs [0021]-[0040], the portions of which are incorporated herein by reference.

The substrate may be finished or semi-finished and the surface roughness and the profile accuracy of the substrate may be controlled. In embodiments, the substrate may have a surface roughness (as measured by arithmetic average or root mean square value) of less than about 10 nm, such as less than about 5 nm. Additionally, the profile accuracy of the substrate may be less than about 0.5 μm, such as less than 0.3 μm. The profile accuracy is measured by a contact type profilometer as appreciated by one skilled in the art.

The system further comprises a coating. The coating of the system comprises a titanium aluminum nitride coating. The stochiometry of the coating is TiAlₓN_{y} where x is about 0.7-1.5 and y is about 2.0-3.0. In other embodiments, the coating may be TiAl_{0.8-1.2}N_{2.2-3.0}, for example, TiAl_{0.8-1.2}N_{2.2-2.7}. In embodiments, the system may include more than one coating layer. While not being bound to one theory, it is theorized that the extra nitrogen stabilizes against oxygen pickup by passivating the surface.

The coating may be applied to at least a portion of the substrate. In embodiments, the coating may be applied on and/or coat an entire surface area of the substrate. The coating may be applied to the substrate such that a dense defect coating is achieved in a number of ways as appreciated by one skilled in the art. Suitable methods of applying the coating to the substrate include but are not limited to the filtered arc, magnetron sputtering, plasma enhanced CVD, ion plating and the like, as well as cathodic arc deposition.

The thickness of the coating on the substrate may be less than about 1.0 μm, such as less than about 0.7 μm, and such as less than about 0.5 μm. The coating is applied such that the surface conditions and profile accuracy of the uncoated mold are substantially maintained.

In embodiments, the profile accuracy of the coated substrate may be less than about 0.5 μm, such as less than 0.3 μm as measured, for example, with a contact type profilometer. The surface roughness (as measured by arithmetic average or root mean square value) of the coating in the as-deposited state may be less than abut 5 nm, such as less than about 3 nm.

The inventors have unexpectedly found that a sub-μm thin TiAlN coating as described herein can be used for high temperature glass molding applications and in embodiments, can eliminate post coat processing steps. Such behavior is achieved by the use of a high purity substrate and/or a coating stoichiometry and/or thickness as described herein. While not being bound to a specific theory, the inventors have found that diffusion of minor constituents such as cobalt and other species in the substrate is limited by the use of the coating described herein even at high temperatures. Therefore, the inventors have found that systems including a thin titanium aluminum nitride coating as described herein on a high purity substrate demonstrate unexpected and superior properties, including, for example, inertness for glass molding applications at high temperatures and/or with reactive glass.

In other embodiments, the system may include a substrate and at least one intermediate layer and a coating. The intermediate layer may be used with substrate materials described herein or any other suitable substrate materials and with the coating described herein. The at least one intermediate layer may be a diffusion barrier layer and is located between the substrate and the coating. Suitable intermediate layers include high purity materials, such as tungsten carbide, tungsten, or a combination thereof having no more than 1.2 wt. % minor constituents.

In other embodiments, the invention is directed to a method of making a mold for precision glass molding. The mold may be used at high temperatures and/or with reactive glass. The method may include preparing and/or manufacturing a substrate. The substrate may be made in any manner as appreciated by one skilled in the art to achieve a dense and/or defect free substrate. In embodiments, the substrate may have a density of at least 98% of theoretical density and a void volume of less than 2%. The substrate may be a high purity tungsten carbide substrate with a total amount of minor constituents and impurities being about less than 1.2 wt. %. The minor constituents may include cobalt, nickel, vanadium, chromium, titanium and the like, as well as impurities such as iron, calcium and potassium. In an embodiment, the substrate may consist essentially of monotungsten carbide. After producing the substrate, the method may include a finishing step. For example, the substrate may be finished by any method as appreciated by one skilled in the art. The surface finish or roughness of the substrate may be less than about 5 nm. The profile accuracy deviation of the substrate may be less than about 0.3 μm. In other embodiments, the method may include additional processing steps such as a surface treatment to remove grinding texture and/or promote coating adhesion.

The method may then include applying a coating to the substrate. The coating may have a composition of TiAl_{0.7-1.5}N_{2.0-3.0}, such as TiAl_{0.7-1.5}N_{2.2-3.0}. The thickness of the coating may be about less than 1.0 μm, such as less than 0.7 μm, and such as less than 0.5 μm. The coating is applied such that the as-deposited coated substrate surface retains and/or has substantially the same surface finish and profile accuracy of the uncoated substrate. In embodiments, the coated substrate has a surface roughness of less than about 5 nm. The coating may be deposited on the substrate by any method as appreciated by one skilled in the art. Suitable methods include any variant of the filtered arc or magnetron sputtering PVD technologies as well as plasma enhanced CVD, ion plating and the like, and cathodic arc deposition.

In other embodiments, the method may include preparing a substrate, applying an intermediate layer and applying a coating on the intermediate layer. The substrate may be any material. For example, the substrate may have a minor constituents content of less than 1.2 wt. %. The intermediate layer may be a diffusion barrier layer. Suitable intermediate layers include high purity tungsten carbide as described herein, tungsten, or a combination thereof. The high purity tungsten carbide intermediate layer may have a minor constituents content of less than 1.2 wt. %. The coating may have a composition of TiAl_{0.7-1.5}N_{2.0-3.0}, such as TiAl_{0.8-1.2}N_{2.2-2.7}. In embodiments, multiple intermediate layers and/or multiple coating layers may be applied. The method may optionally include surface finishing steps after preparing the substrate, after applying the intermediate layer and/or after applying the coating. Surface finishing steps include, for example, surface treatments. The coated substrate preferably has a surface roughness substantially similar to that of the surface roughness of the uncoated substrate.

The following examples are intended to illustrate the invention and should not be construed as limiting the invention in any way.

### EXAMPLES

The first test examined the stability of the inventive coating compared to conventional coatings, DCL and TiN, under molding environments (flowing nitrogen) of 670° C. in the absence of glass. The substrate used was a tungsten carbide substrate with a total minor constituents of less than 0.5 wt. % having less than 0.2 wt. % cobalt. Three substrates were coated with three different coatings and then tested for stability. The first substrate was coated with DLC (diamond like carbon), the second substrate was coated with TiN (Ti₅₀N₅₀) and the third substrate was coated with the inventive coating having a stoichiometry of Ti₂₂Al₂₂N₅₅. The comparative coatings, DLC and TiN were obtained from commercial vendors. The coated substrates were then tested for stability at high temperatures.

The samples, individually, were tested in a tube furnace with flowing UHP N₂ that simulated glass molding conditions. Each sample was introduced into the hot zone of the furnace and held at a temperature of about 670° C. for 4 minutes and then cooled down.

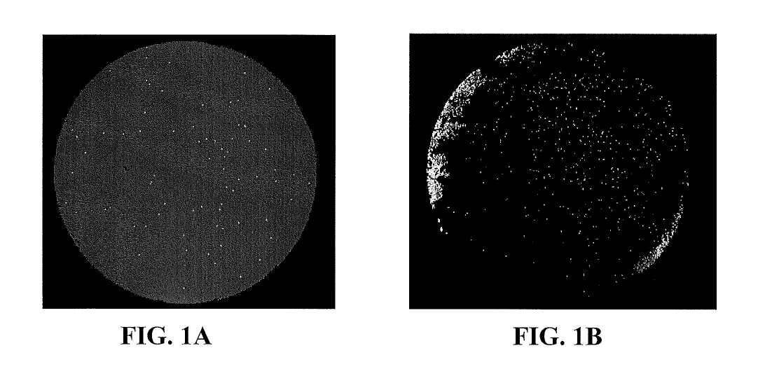

FIGS. 1, 2, and 3 are SEM photomicrographs of the DLC, TiN and inventive TiAlN coating, respectively, on the tungsten carbide substrate before and after heat treatment at 670° C. FIG. 1A shows the as-coated DLC tungsten carbide substrate before heat treatment and FIG. 1B shows the same material after heat treatment. The measured surface roughness (RMS) of the pre-heat treated DLC coated carbide material as shown in FIG. 1A was 2±1 nm and after heat treating as shown in FIG. 1B was greater than 200 nm The drastic change in surface roughness before and after treatment clearly illustrates the extensive degradation of the coating and hence the instability of the DLC coating at high temperature.

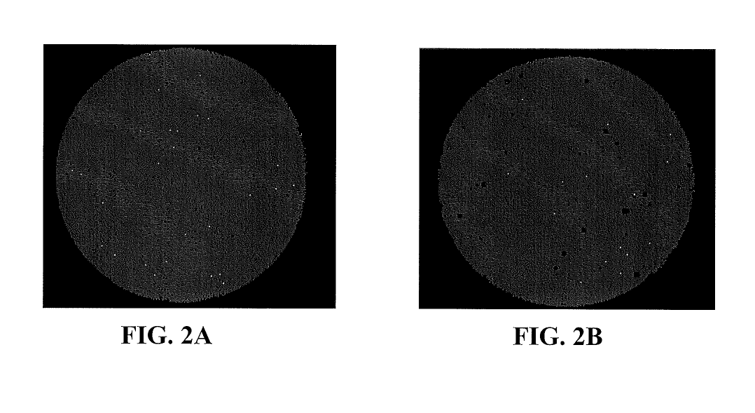

FIG. 2A illustrates the as-coated TiN coated tungsten carbide substrate before heat treatment and FIG. 2B shows the same material after heat treatment. The measured surface roughness (RMS) of the TiN coated substrate as shown in FIG. 2A was 7±1 nm and after heat treating as shown in FIG. 2B was 62±1 nm. The difference in surface roughness of the TiN coated substrate also demonstrated instability of the coating as evidenced by the at least partial degradation of the coating.

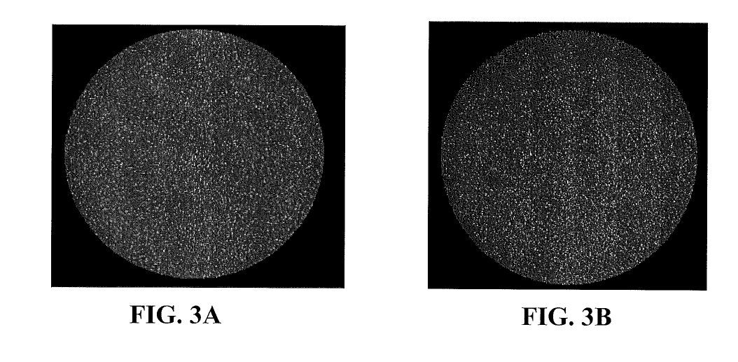

FIG. 3A illustrates the as-coated inventive Ti₂₂Al₂₂N₅₅ (TiAl₁N_{2.5}) coated tungsten carbide substrate before heat treatment and FIG. 3B shows the same material after heat treatment. The measured surface roughness (RMS) of the TiAlN coated substrate as shown in FIG. 3A was 1±1 nm and after heat treating as shown in FIG. 3B was 2±1 nm, thereby evidencing minimal change or reactivity and/or degradation of the inventive coating at high temperatures. In particular, FIG. 3B illustrates minimal, if any, degradation of the coating after the heat treatment. Additionally, the inventive coating demonstrated a significantly lower reactivity and/or coating degradation than that of the DLC and TiN coatings.

A second test was performed to test the inertness of the inventive coating with two reactive glass compositions. Glass Composition A is a non-silicate glass which was molded at a maximum temperature of 550° C. and Glass Composition B is a fluorine and potassium containing silicate glass which was molded at a maximum temperature of 650° C. Of the two reactive glass compositions, Glass Composition B is more reactive than Glass Composition A because it has a higher softening point and the presence of the additional elements, fluorine and potassium. The compositions of the glasses were determined by energy dispersive x-ray spectroscopy (EDS) and are set forth in Table 1.

TABLE 1

| | |
|---|---|
| Element | EDS comp (at %) |

Glass Composition A

| | |
|---|---|
| O | 65 |
| P | 12 |
| Ge | 3 |
| Nb | 10 |
| W | 45 |
| Bi | 45 |

Glass Composition B

| | |
|---|---|
| O | 63 |
| F | 7 |
| Si | 22 |
| K | 8 |

In this test, the inventive coatings on a high purity substrate were tested for stability and inertness at high temperature when in contact with each glass composition. The inventive coated utilized was Ti₂₂Al₂₂N₅₅ as illustrated in Table 2. A 0.3 μm coating was applied to a tungsten carbide substrate having less than 0.5 wt. % minor constituents, having less than 0.2 wt. % cobalt.

The high temperature stability and inertness test was conducted in a tube furnace with flowing UHP N₂ that simulated glass molding conditions. Each coated tungsten carbide substrate was introduced into the hot zone of the furnace and held at a temperature of about 650° C. for 4 minutes and then cooled down. In order to test inertness, a piece of glass of each composition, respectively, was placed on the coated substrate during the test. This cycle was repeated 5 times for each coated substrate with the two different glass compositions. The reaction of the glass and the coating was determined by visual observation, scanning electron microscopy and EDAX composition analysis of the surface. The surface roughness of the coatings on the coated substrate were determined by non-contact laser based optical profiler measurements before and after testing. For example, any surface reactions that caused a change in the roughness of the sample surface were measured by the optical profiler. The results are shown in Table 2.

TABLE 2

| | | In Contact | Temp | Initial | After | |
|---|---|---|---|---|---|---|
| Sample | Coating | With | (° C.) | RMS | RMS | EDAX |
| Inventive | Ti₂₂Al₂₂N₅₅ | Glass | 550 | 1 | 2 | Ti₂₃Al₂₃N₅₄ |
| | | Comp. A | | | | |
| Inventive | Ti₂₂Al₂₂N₅₅ | Glass | 650 | 2 | 3 | Ti₂₂Al₂₂N₅₆ |
| | | Comp. B | | | | |

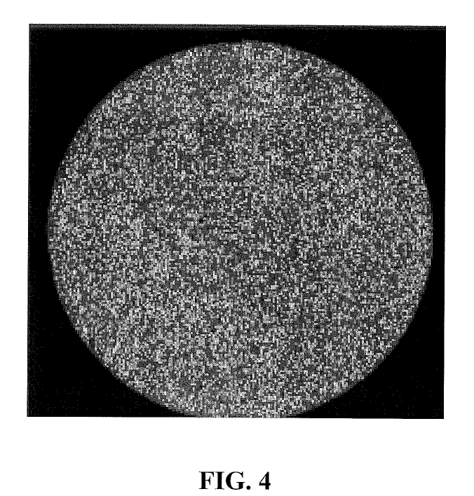

As can be seen, the inventive coating demonstrated inertness and stability at high temperatures as well as when in contact with both reactive glass compositions. The chemical composition of the inventive coating in contact with Glass Composition A as determined by EDAX after exposure to high temperature was Ti₂₃Al₂₃N₅₄. The minimal change in chemistry evidenced the relative stability of the inventive coating on a high purity substrate at high temperature. Additionally, the measured surface roughness (RMS) of this sample prior to exposure to high temperature was about 1 nm, and after exposure was about 2 nm. FIG. 4 is an SEM photomicrograph of the inventive coating in contact with Glass Composition A after exposure to 550° C. As shown in FIG. 4, the change in surface roughness after heat treating was minimal (as compared to FIG. 3A illustrating the coated substrate before heat treatment), further evidencing the stability of the coating at high temperatures. Again, the minimal change in surface roughness and chemistry composition of this sample demonstrated the stability and inertness of the inventive composition even when in contact with a reactive glass and at high temperatures.

FIG. 5 is an SEM photomicrograph of the inventive coating in contact with Glass Composition B after exposure to 650° C. The measured surface roughness of this sample prior to exposure to high temperature was about 2 nm, and after exposure was about 3 nm. The composition of the coating after exposure as measured by EDAX was Ti₂₂₋Al₂₂N₅₆. Again, the minimal change in surface roughness and chemistry composition of this sample demonstrated the stability and inertness of the inventive composition even when in contact with a highly reactive glass and at high temperatures.

The next test compared the stability and inertness of the inventive coating with three comparative coatings shown in Table 3 in the presence of the more reactive glass composition, Glass Composition B. The inventive coating utilized was Ti₂₂Al₂₂N₅₅. The coatings were applied on a tungsten carbide substrate with minor constituents of less than about 0.5 wt. %, minor constituents having less than 0.2 wt. % cobalt. The thickness of the coatings on each substrate was about 0.3 μm.

A similar test for stability and inertness as described above was performed with Comparative Coatings A-C having the compositions listed in Table 2. Specifically, the inventive and comparative samples were placed in contact with Glass Composition B, the more reactive glass at a temperature of 650° C. in a nitrogen atmosphere for 4 minutes and then cooled down. The cycle was repeated five times for each sample.

TABLE 3

| | | Temp | Initial | After | |
|---|---|---|---|---|---|
| Sample | Coating | (° C.) | RMS | RMS | EDAX |
| Inventive | Ti₂₂Al₂₂N₅₅ | 650 | 2 | 3 | Ti₂₂Al₂₂N₅₆ |
| Comp. A | Ti₁₆Al₂₇N₅₇ | 650 | 2 | >200 | Ti₁₁Al₂₀Si₃K₂N₁₇O₄₇ |
| Comp. B | DLC | 650 | 2 ± 1 | >200 | Substrate: W₂₀C₂₀; |
| | | | | | C₁₀O₅₀ |
| Comp. C | TiN | 650 | 5 ± 1 | 59 ± 1 | Ti₃₁K₃O₆₆ |

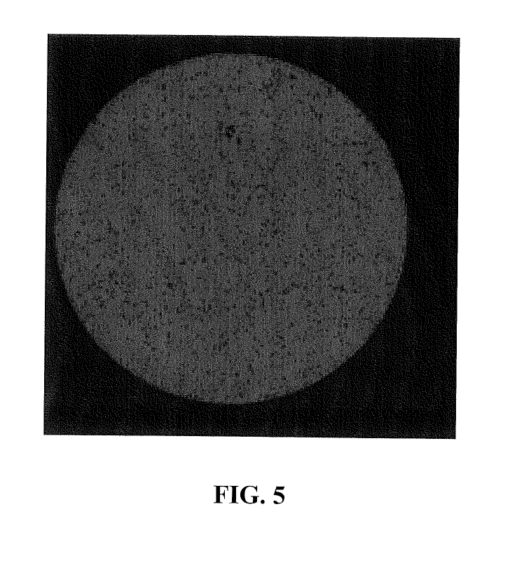

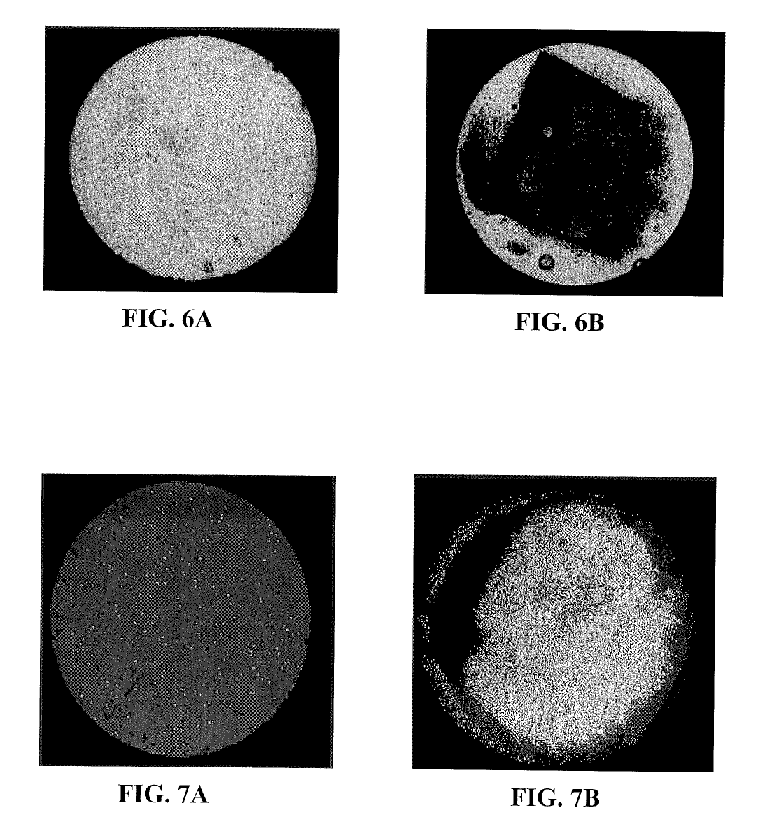

The Comparative A sample was a substrate having a coating of Ti₁₆Al₂₇N₅₇. FIG. 6A is an SEM photomicrograph of the Comparative A sample before exposure to high temperature and FIG. 6B illustrates the sample after exposure to the high temperature. The initial surface roughness of the Comparative A sample was 2 nm and after exposure to high temperature was greater than 200 nm. The composition of the coating as measured by EDAX of Comparative A after exposure to high temperature was Ti₁₁Al₂₀Si₃K₂N₁₇O₄₇. The aluminum rich coating was prone to oxidation and reacted with the reactive glass composition, and therefore, had decreased inertness.

The Comparative B sample was a substrate coated with DLC. FIG. 7A is an SEM photomicrograph of the Comparative B sample prior to exposure to high temperature having a surface roughness of 2±1 nm. FIG. 7B is an SEM photomicrograph of the sample after high temperature exposure and having a surface roughness of greater than 200 nm. Additionally, the composition measured by EDAX after heat treatment included an analysis of the substrate as the coating was in such a degraded state.

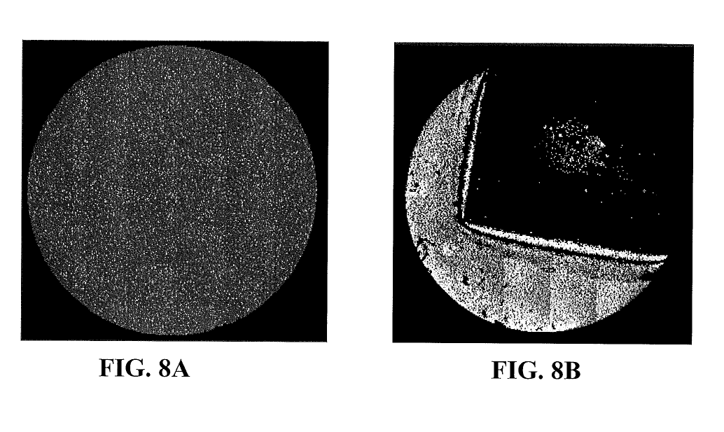

The Comparative C sample was a substrate coated with TiN. FIG. 8A is an SEM photomicrograph of the Comparative C sample prior to exposure to high temperature and having a surface roughness of 5±1 nm FIG. 8B is an SEM photomicrograph of the Comparative C sample after exposure to high temperature and having a surface roughness of 69±1 nm. The EDAX composition measured after heat treatment evidenced a fairly significant change in chemical composition. Therefore, there was a relatively high degree of instability of the coating and reactivity with the reactive glass at high temperatures.

As seen by at least the substantial increase in surface roughness after exposure to high temperature, the coatings of Comparative A-C samples have significant instability as well as interaction and/or reactivity with the reactive glass at high temperature.

Additionally, as discussed above and seen in FIG. 5, the inventive TiAlN coating, Ti₂₂Al₂₂N₅₅ with an atomic ratio of 1:1:2.5 retained its surface finish and composition. Additionally, EDAX analysis after heat treatment evidenced minor changes in the composition. Thus, the inventive coating was highly stable and inert at high temperatures. In contrast, as shown in FIG. 6B, a TiAlN coating with an atomic ratio of 1:1.7:3.6, as well as FIGS. 7B and 8B, the DLC and TiN coatings, respectively, show interaction with Glass Composition B glass after exposure to high temperature. From tests on TiN, TiAlN and Al rich TiAlN coatings, it has been determined that as the Ti:Al atomic ratio deviates appreciably from 1:1, the reactivity of the coating increases. The test results further demonstrated that a thin, for example, less than 0.5 μm TiAlN coating as described herein, on a high purity WC substrate having less than about a 5 nm surface finish, and a profile tolerance of less than about 0.5 μm of a precision glass molding mold remained inert to the higher temperature reactive glasses during molding operation.

Thus, the coatings of the present invention effectively provide higher glass product quality and productivity, higher possible glass molding process temperatures without die fatigue or failure, closer control of dimensional tolerances of glass product, longer service life of dies and tools, and lower cost of die manufacturing because of the cheaper elements used in the system.

The system described herein produces forming tools that are oxidation resistant and wear resistant at high temperatures, and further provides a surface to which glass does not stick. These properties in the tools allow the production of glass components without interruption and material loss, and thus, the life of a tool and the quality and productivity of glass products to be significantly extended. This new coating architecture and design is particularly suited for precision glass molding or forming processes, and while it is anticipated herein that the coating and/or system can be utilized in tooling for molding precision glass lenses for imaging applications, for example, molding reactive glass and/or molding glass at high temperatures, it is not limited to such applications. Additional use of the coating and/or system includes but is not limited to molding of laser collimator lens, molding of other articles that require fully dense, high hardness tungsten carbide, and mirrors.

Whereas, particular embodiments of this invention have been described above for purposes of illustration, it will be evident to those skilled in the art that numerous variations of the details of the present invention may be made without departing from the invention as defined in the appended claims.

What is claimed is:

1. A coating composition comprising TiAlₓN_{y}, wherein x is about 0.7-1.5 and y is about 2.2-3.0.

2. The coating composition according to claim 1, wherein x is about 0.8-1.2.

3. The coating composition according to claim 1, wherein y is about 2.2-2.7.

4. A substrate coated with the coating composition of claim 1.

5. The substrate according to claim 4, having a coating thickness of less than about 1.0 μm.

6. A system for precision glass molding, comprising:
a substrate; and
a coating on at least a portion thereon, wherein the coating comprises TiAlₓN_{y}, wherein x is about 0.7-1.5 and y is about 2.0-3.0.

7. The system according to claim 6, wherein x is about 0.8-1.2.

8. The system according to claim 6, wherein y is about 2.2-2.7.

9. The system according to claim 6, wherein the substrate has a coating thickness of less than about 1.0 μm.

10. The system according to claim 9, wherein the coating thickness is about 0.5 μm.

11. The system according to claim 6, wherein the surface roughness (RMS) of the coated substrate is about less than about 5 nm.

12. The system according to claim 6, wherein the coated substrate has a profile accuracy of less than about 0.5 μm.

13. The system according to claim 6, wherein the substrate comprises tungsten carbide, tungsten or a combination thereof having less than 1.2% minor constituents.

14. The system according to claim 13, wherein the minor constituents comprise at least one of cobalt, chromium or nickel.

15. The system according to claim 6, wherein the substrate comprises monotungsten carbide having less than 1.2 wt. % minor constituents.

16. A method comprising:
applying a coating to a substrate, wherein the substrate comprises tungsten carbide, tungsten or a combination thereof having less than 1.2 wt. % minor constituents, and wherein the coating comprises TiAlₓN_{y}, wherein x is about 0.7-1.5 and y is about 2.2-3.0.

17. The method according to claim 16, wherein x is about 0.8-1.2 and y is about 2.2-2.7.

18. The method according to claim 16, wherein the coating thickness is less than about 1.0 μm.

19. The method according to claim 16, wherein the minor constituents comprise at least one of cobalt, chromium or nickel.

20. The method according to claim 16, further comprising applying an intermediate layer prior to coating the substrate, wherein the intermediate layer comprises tungsten carbide, tungsten or a combination thereof.
